(19) United States
(12) Patent Application Publication
(10) Pub. No.: US 2023/0193035 A1
(43) Pub. Date: Jun. 22, 2023

(54) CROSSLINKED-POLYMER MODIFIED ASPHALT COMPOSITIONS AND METHODS OF MAKING AND USING THEREOF

(71) Applicant: MARATHON PETROLEUM COMPANY LP, Findlay, OH (US)

(72) Inventors: Cristian S. Clopotel, Findlay, OH (US); Anas A. Jamrah, Findlay, OH (US); Brian K. Wilt, Findlay, OH (US); Stormy R. Brewster, Findlay, OH (US)

(21) Appl. No.: 18/082,091

(22) Filed: Dec. 15, 2022

Related U.S. Application Data
(60) Provisional application No. 63/265,548, filed on Dec. 16, 2021.

(51) Int. Cl. C08L 95/00; C08L 91/00; C08L 9/06

(52) U.S. Cl. CPC C08L 95/005; C08L 9/06; C08L 91/005; C08L 2201/02; C08L 2312/02; C08L 2555/64

(57) ABSTRACT

Compositions and methods for the production of crosslinked polymer modified asphalt containing renewable products, such as ester bottoms or byproducts of soy oil or corn oil. Such compositions and methods may be used to reduce fire and explosion hazards associated with sulfur in preparation of crosslinked polymer modified asphalt.

### CROSS REFERENCE TO RELATED APPLICATIONS

This application claims priority to, and the benefit of U.S. Provisional Application No. 63/265,548, filed Dec. 16, 2021, titled “CROSSLINKED-POLYMER MODIFIED ASPHALT METHODS AND COMPOSITIONS, FOR REDUCING FIRE AND EXPLOSION HAZARDS AND ENHANCING LOW TEMPERATURE PERFORMANCE,” the disclosures of which are incorporated herein by reference in its entirety.

### TECHNICAL FIELD

The present disclosure relates to crosslinked polymer modified asphalt compositions and methods of making these compositions to reduce fire and explosion hazards.

### BACKGROUND

Crosslinking agents are used in polymer modified asphalts to stabilize the polymer network of the polymer modified asphalts. Sulfur is a commonly used crosslinking agent that is added to the polymer modified asphalts in powdered form. However, in powdered form, sulfur creates fire and explosion hazards. Fluxing components are therefore used as a sulfur carrier to blend with the sulfur to reduce the risks associated with sulfur. Fluxing components, such as paraffinic and aromatic materials, help keep the sulfur particles suspended as the fluxing components having a higher viscosity. So, a mixture of the fluxing component and sulfur is used as a crosslinking agent to the polymer modified asphalt. However, primary constraints on fluxing components include safety and compatibility with the sulfur. These fluxing components usually include gas oils or poly(alphaolefins) that are sources of valuable products for a refinery.

### SUMMARY

Provided here are compositions and methods to address these shortcomings of the art and provide other additional or alternative advantages. Applicant has recognized that renewable and/or recyclable products, such as ester bottoms, may be used as a sulfur carrier for crosslinked polymer modified asphalt compositions and reduce fire and explosion hazards. Use of ester bottoms reduces the consumption of fluxing components that are sources of valuable products for a refinery.

The addition of ester bottoms to asphalt provides refiners an opportunity to use low value byproduct waste of refining methyl ester, including biodiesel. Rather than utilizing additional products capable of maintaining the high temperature compliance of the crosslinked polymer modified asphalt, refineries can recycle ester bottoms, a waste byproduct of refining. Thus, these methods and systems lead to sustainable crosslinked polymer modified asphalt compositions and effectively provide cost savings to the refinery.

In certain embodiments, a method of producing a crosslinked polymer modified asphalt includes blending sulfur with ester bottoms to form a sulfur-ester bottoms mixture. The sulfur-ester bottoms mixture contains about 1 weight percent (wt.%) to about 50 wt.% of the sulfur and about 50 wt.% to about 99 wt.% of the ester bottoms. The sulfur may be blended with the ester bottoms at a temperature ranging from about 15° C. (°C) to about 24° C. for a time period ranging from about 10 minutes to about 30 minutes. The method further includes mixing the sulfur-ester bottoms mixture with a polymer modified asphalt to produce a crosslinked polymer modified asphalt. The sulfur-ester bottoms mixture is added to the polymer modified asphalt in an amount to achieve a preselected useable temperature range of the crosslinked polymer modified asphalt composition. The sulfur-ester bottoms mixture may be mixed with the polymer modified asphalt at a temperature range from about 15° C. to about 24° C. for a time period from about 1 hour to about 2 hours. The method may further include the following steps to obtain the ester bottoms: reacting methanol and dry oil to generate reaction products with at least methyl ester and glycerin, removing at least a portion of the glycerin from the reaction products to leave an ester phase, and distilling the ester phase to separate purified methyl esters and recover distillation bottoms as ester bottoms. The dry oil may include one or more of a vegetable oil or an animal fat that has at least some moisture removed therefrom prior to reaction with the methanol.

In certain embodiments, a crosslinked polymer modified asphalt composition contains about 99.6 wt.% to about 99.9 wt.% of the polymer modified asphalt and about 0.1 wt.% to about 0.4 wt.% of a sulfur-ester bottoms mixture. In certain embodiments, a crosslinked polymer modified asphalt composition contains about 99.8 wt.% of the polymer modified asphalt and about 0.2 wt.% of a sulfur-ester bottoms mixture. In certain embodiments, the polymer in the crosslinked polymer modified asphalt includes one or more of styrene butadiene (SB) copolymers or styrene-butadiene-styrene (SBS) copolymers. The sulfur-ester bottoms mixture may contain about 1 weight percent (wt.%) to about 50 wt.% of the sulfur. The polymer modified asphalt may be one or more of a styrene-butadiene-styrene modified asphalt, styrene butadiene modified asphalt, or crumb rubber modified asphalt. The sulfur may be in a powdered form when being blended with the ester bottoms.

In certain embodiments, the crosslinked polymer modified asphalt contains about 0.1 wt.% to about 0.4 wt.% of the sulfur-ester bottoms mixture. In certain embodiments, the crosslinked polymer modified asphalt contains about 0.2 wt.% of the sulfur-ester bottoms mixture. In certain embodiments, a strain recovery rate of the crosslinked polymer modified asphalt with the sulfur-ester bottoms mixture is not less than the strain recovery rate of a crosslinked polymer modified asphalt containing a neutral oil and without the ester bottoms. In certain embodiments, a high temperature compliance of the crosslinked polymer modified asphalt with the sulfur-ester bottoms mixture is within 5% of the high temperature compliance of a crosslinked polymer modified asphalt containing a neutral oil and without the ester bottoms. In certain embodiments, a high temperature compliance of the crosslinked polymer modified asphalt with the sulfur-ester bottoms mixture is within 1% of the high temperature compliance of a crosslinked polymer modified asphalt containing a neutral oil and without the ester bottoms. The polymer modified asphalt may be one or more of a styrene-butadiene-styrene modified asphalt, styrene butadiene modified asphalt, or crumb rubber modified asphalt. The sulfur may be in a powdered form when being blended with the ester bottoms. The ester bottoms may be obtained as distillation bottoms of a distilled methyl ester product that results from reaction between methanol and at least one of vegetable oil or animal fat from which glycerin is settled and removed from the methyl ester product prior to distillation.

In certain embodiments, a crosslinked styrene-butadiene-styrene (SBS) modified asphalt composition contains a SBS modified asphalt and a sulfur-ester bottoms mixture. The sulfur-ester bottoms mixture contains about 1 wt.% to about 50 wt.% of the sulfur and about 50 wt.% to about 99 wt.% of the ester bottoms. In certain embodiments, the crosslinked SBS modified asphalt contains 99.6 wt.% to about 99.9 wt.% of the SBS modified asphalt. In certain embodiments, the crosslinked SBS modified asphalt contains about 0.1 wt.% to about 0.4 wt.% of the sulfur-ester bottoms mixture. In certain embodiments, a strain recovery rate of the crosslinked SBS modified asphalt with the sulfur-ester bottoms mixture is not less than the strain recovery rate of a crosslinked SBS modified asphalt containing a neutral oil and without the ester bottoms. In certain embodiments, a high temperature compliance of the crosslinked SBS modified asphalt with the sulfur-ester bottoms mixture is within 5% of the high temperature compliance of a crosslinked-SBS modified asphalt containing a neutral oil and without the ester bottoms. In certain embodiments, a high temperature compliance of the crosslinked SBS modified asphalt with the sulfur-ester bottoms mixture is within 1% of the high temperature compliance of a crosslinked SBS modified asphalt containing a neutral oil and without the ester bottoms. The ester bottoms may be obtained as distillation bottoms of a distilled methyl ester product that results from reaction between methanol and at least one of vegetable oil or animal fat from which glycerin is settled and removed from the methyl ester product prior to distillation.

### BRIEF DESCRIPTION OF DRAWINGS

These embodiments and other features, aspects, and advantages of the disclosure will be better understood in conjunction with the following descriptions, claims, and accompanying drawings. It is to be noted, however, that the drawings illustrate only certain embodiments of the disclosure and, therefore, are not to be considered limiting of the scope of the disclosure.

FIG. 1 is an illustrative block diagram for producing crosslinked polymer modified asphalt from sulfur, ester bottoms, and polymer modified asphalt, according to an embodiment of the disclosure.

FIG. 2 is a flow diagram of the method of production of crosslinked polymer modified asphalt from sulfur, ester bottoms, and polymer modified asphalt, according to an embodiment of the disclosure.

FIG. 3 is a graphical representation of a comparison of high temperature compliance of a control asphalt sample (crosslinked polymer modified asphalt with a neutral oil and without ester bottoms) and crosslinked polymer modified asphalt (with ester bottoms) measured as original binders (unaged binders) and rolling thin-film oven aged binders, according to an embodiment of the disclosure.

FIG. 4 is a graphical representation of a comparison of the rate of recovery of a control sample (crosslinked polymer modified asphalt with a neutral oil and without ester bottoms) and a crosslinked polymer modified asphalt (with ester bottoms), according to an embodiment of the disclosure.

### DETAILED DESCRIPTION

So that the manner in which the features and advantages of the embodiments of the compositions and methods disclosed herein, as well as others, which will become apparent, may be understood in more detail, a more particular description of embodiments of compositions and methods is provided. In the following description, numerous details are set forth in order to provide a thorough understanding of the various embodiments. In other instances, well-known processes, devices, and systems may not be described in particular detail in order not to unnecessarily obscure the various embodiments. Additionally, illustrations of the various embodiments may omit certain features or details in order to not obscure the various embodiments.

The present disclosure is directed to crosslinked polymer modified asphalt compositions and methods for the production of these crosslinked polymer modified asphalts. These compositions reduce or eliminate fire and explosion hazards associated with sulfur. Certain embodiments include compositions that contain polymer modified asphalt and a mixture of sulfur and ester bottoms. Other embodiments include methods for producing the crosslinked polymer modified asphalt from such polymer modified asphalt and mixture of sulfur and ester bottoms. In certain embodiments, these compositions with ester bottoms have similar temperature performance and strain recovery rate as compared to crosslinked polymer modified asphalt with previously described fluxing components.

In certain embodiments, a crosslinked polymer modified asphalt composition contains about 99.6 wt.% to about 99.9 wt.% of the polymer modified asphalt and about 0.1 wt.% to about 0.4 wt.% of a sulfur-ester bottoms mixture. In certain embodiments, a crosslinked polymer modified asphalt composition contains about 99.8 wt.% of the polymer modified asphalt and about 0.2 wt.% of a sulfur-ester bottoms mixture. In certain embodiments, the polymer in the crosslinked polymer modified asphalt includes one or more of styrene butadiene (SB) copolymers or styrene-butadiene-styrene (SBS) copolymers.

In certain embodiments, the polymer in the crosslinked polymer modified asphalt has one or more monomers selected from the group consisting of butadiene, styrene, vinyl acetate, ethylene, propylene, acrylate, isoprene, and acrylamide. The sulfur-ester bottoms mixture may contain about 1 weight percent (wt.%) to about 50 wt.% of the sulfur. The polymer modified asphalt may be one or more of a styrene-butadiene-styrene modified asphalt, styrene butadiene modified asphalt, or crumb rubber modified asphalt. The sulfur may be in a powdered form when being blended with the ester bottoms.

In certain embodiments, a crosslinked polymer modified asphalt composition may contain about 90 wt.% to about 99.95 wt.% of the polymer modified asphalt. In certain embodiments, a crosslinked polymer modified asphalt composition may contain about 92 wt.% to about 99.94 wt.% of the polymer modified asphalt, or about 92.5 wt.% to about 99.9 wt.%, or about 93 wt.% to about 99.9 wt.%, or about 94 wt.% to about 99.9 wt.%, or about 95 wt.% to about 99.9 wt.%, or about 95.5 wt.% to about 99.9 wt.%, or about 97 wt.% to about 99.9 wt.%, or about 98.5 wt.% to about 99.9 wt.%, or about 99 wt.% to about 99.9 wt.%, or about 99.5 wt.% to about 99.9 wt.%, or about 99.5 wt.% to about 99.9 wt.%. In addition, the crosslinked polymer modified asphalt composition may contain about 0.1 wt.% to about 10 wt.% of a sulfur-ester bottoms mixture. In certain embodiments, a crosslinked polymer modified asphalt composition may contain about 0.1 wt.% to about 8 wt.% of a sulfur-ester bottoms mixture, or about 0.1 wt.% to about 7 wt.%, or about 0.1 wt.% to about 6 wt.%, or about 0.1 wt.% to about 5.5 wt.%, or about 0.1 wt.% to about 5 wt.%, or about 0.1 wt.% to about 4 wt.%, or about 0.1 wt.% to about 3 wt.%, or about 0.1 wt.% to about 2 wt.%, or about 0.2 wt.% to about 2 wt.%, or about 0.2 wt.% to about 1 wt.%, or about 0.2 wt.% to about 0.5 wt.%, or about 0.1 wt.%, or about 0.2 wt.%, about 0.3 wt.%. The sulfur-ester bottoms mixture may contain sulfur and ester bottoms. The polymer modified asphalt may contain a polymer and unmodified asphalt. Sulfur includes elemental sulfur. The addition of sulfur-ester bottoms mixture to the polymer modified asphalt in terms of a higher percentage of the sulfur to the polymer modified asphalt, maybe detrimental to the crosslinking treatment of the polymer modified asphalt. In certain embodiments, the asphalt can include from about 20 wt.% to about 60 wt.% recycled asphalt.

The term “about” refers an acceptable error for a particular value as determined by one of ordinary skill in the art using measurements in accordance with the referenced standards for the experiments. In embodiments, “about” may include values within a standard deviation of a specified value, which depends in part on how the value is measured or determined. In one nonlimiting embodiment, when the term “about” is used with a particular value, then “about” refers to a range extending to ±10% of the specified value, alternatively ±5% of the specified value, or alternatively ±1% of the specified value, or alternatively ±0.5% of the specified value. In embodiments, “about” refers to the specified value.

Ester bottoms as used herein are a byproduct of methyl ester refining. Ester bottoms are a low value by-product of vegetable oil or animal fat refining to produce methyl ester Ester bottoms are currently marketed for animal feed, lubricants, or other industrial uses at a low price point. The addition of ester bottoms provides refiners the opportunity to use low value byproduct waste of refining methyl ester. Additionally, the crosslinked polymer modified asphalt that incorporates ester bottoms into the composition maintains properties of other crosslinked polymer modified asphalt that incorporate fluxing components into the composition. Fluxing components include gas oils such as neutral oils. Feedstock containing all or a portion of vegetable oil or animal fats are reacted and refined to produce a variety of finished products including methyl esters, such as biodiesel. Out of the variety of finished products produced from methyl esters, on the low end of the value spectrum are ester bottoms. Ester bottoms are a residual byproduct of refining biodiesel and are not glycerin or skimmed fatty acids. As such, ester bottoms may contain one or more methyl esters, sodium soap, monoglycerides, diglycerides, triglycerides, or unsaponifiables. The unsaponafiables may make up at least about 10% of the ester bottoms. Additionally, ester bottoms may have a viscosity range 10-900 centipoise (cP) at 64° C. (°C).

In certain embodiments, the method of manufacturing ester bottoms includes reacting methanol and dry oil to generate reaction products, which include at least methyl ester and glycerin. The dry oil is an oil that is at least partially dried to remove moisture therefrom prior to reaction with the methanol. The dry oil can be derived from one or more of a vegetable oil or an animal fat The method further includes the steps of settling the glycerin from the reaction products, creating a distillation feedstock that has at least a portion of the glycerin removed from die reaction products, distilling the distillation feedstock, and recovering the distillation bottoms as ester bottoms. The ester bottoms thus produced are blended with sulfur.

In certain embodiments, the method of manufacturing ester bottoms includes reacting methanol with dry oil containing one or more of a vegetable oil or an animal fat to generate reaction products with at least methyl ester and glycerin, settling the glycerin from the reaction products, removing at least a portion of the glycerin from the reaction products to leave an ester phase, distilling the ester phase to separate purified methyl esters from ester bottoms. The ester bottoms thus produced are Mended with sulfur. The reaction of methanol and the dry oil may occur in a multistage continuous reactor and methoxide catalyst may be added to one or more stages of the multistage continuous reactor.

In certain embodiments, the method of manufacturing ester bottoms includes reacting methanol with dry oil containing one or more of a vegetable oil or an animal fat to generate reaction products with at least methyl ester and glycerin, settling the glycerin from the reaction products, removing at least a portion of the glycerin from the reaction products to leave an ester phase, washing the ester phase with water to remove one or more of soap, methanol, catalyst or additional glycerin, drying the washed ester phase to define dried methyl esters, and distilling the dried methyl esters to separate purified methyl esters from ester bottoms. The ester bottoms thus produced are blended with sulfur.

In certain embodiments, the method of manufacturing ester bottoms includes removing moisture from a feedstock containing all or a portion of vegetable oil or animal fats using a dryer to produce a dry oil. The dry oil is then fed into a three-stage continuous reactor/settler system where methoxide catalyst and methanol are added to each stage. In the settler system, methanol reacts with the dry oil to produce methyl ester and glycerin. The dry oil is reacted to less than 1% monoglyceride and virtually negligible diglycerides or triglycerides as it leaves the last settler. Glycerin settles out of the reaction mixture and is directed from the reactors downstream for further refining. As such, the ester phase remains after the glycerin is removed. The ester phase is then transferred to a single stage flash distillation tank to remove any remaining methanol. Next, the ester phase is water washed to remove glycerin, soap, methanol, and the methoxide catalyst to produce a washed methyl ester. The washed methyl esters are then dried under vacuum in an ester dryer to remove more methanol and water. Sodium methoxide is next added to the ester dryer to convert any glycerin and monoglycerides into diglycerides and triglycerides. The methyl esters then leave the ester dryer and are preheated before entering an ester surge tank. These methyl esters from the ester surge tank are then distilled to separate the purified methyl esters from the ester bottoms. The ester bottoms are next transferred from the distillation tower to an ester bottom surge tank while the purified methyl ester is transferred from the distillation tower to a storage tank for distribution or sale. Ester bottoms may be used as a rejuvenator for asphalt. The ester bottoms when added to an asphalt paving composition, help improve the useable temperature range.

Embodiments include methods of making a modified asphalt composition containing about 90 wt.% to about 99.9 wt.% of the polymer modified asphalt and about 0.1 wt.% to about 10 wt.% of a sulfur-ester bottoms mixture. One such method includes the steps of obtaining a distillation bottoms of a distilled methyl ester product that results from reaction between methanol and at least one of vegetable oil or animal fat from which glycerin is settled and removed from the methyl ester product prior to distillation, whereby the distillation bottoms is defined as ester bottoms. The method further includes blending the ester bottoms with sulfur to form a sulfur-ester bottoms mixture containing about 50 wt.% to about 99 wt.% of the ester bottoms and mixing the sulfur-ester bottoms mixture with a polymer modified asphalt to produce a modified asphalt composition containing about 90 wt.% to about 99.9 wt.% of the polymer modified asphalt and about 0.1 wt.% to about 10 wt.% of a sulfur-ester bottoms mixture.

In certain embodiments, compositions contain polymer modified asphalt and a mixture of sulfur and soybean oil byproducts. Soybean oil or soy oil is a widely used vegetable oil for both edible and industrial uses. The most common ester of soybean oil is methyl ester. As such, sulfur may be blended with a byproduct of soybean oil or soy oil processing. Certain embodiments of the crosslinked polymer modified asphalt composition include about 99.6 wt.% to about 99.9 wt.% of the polymer modified asphalt and about 0.1 wt.% to about 0.4 wt.% of a mixture of sulfur and byproduct of soybean oil or soy oil. Certain embodiments of the crosslinked polymer modified asphalt composition include about 99 wt.% to about 99.9 wt.% of the polymer modified asphalt and about 0.1 wt.% to about 1 wt.% of a mixture of sulfur and byproduct of soybean oil or soy oil.

In certain embodiments, compositions contain polymer modified asphalt and a mixture of sulfur and corn oil byproducts. Corn oil is also a widely used vegetable oil that may be refined to produce a variety of finished products, including methyl esters. Sulfur may also be blended with corn oil byproduct. Certain embodiments of the crosslinked polymer modified asphalt composition include about 99.6 wt.% to about 99.9 wt.% of the polymer modified asphalt and about 0.1 wt.% to about 0.4 wt.% of a mixture of sulfur and byproduct of corn oil. Certain embodiments of the crosslinked polymer modified asphalt composition include about 99 wt.% to about 99.9 wt.% of the polymer modified asphalt and about 0.1 wt.% to about 1 wt.% of a mixture of sulfur and byproduct of corn oil.

In some embodiments, the sulfur is in a powdered form. In powdered form, the powder may be finely ground or in divided form. Sulfur may include elemental sulfur. The Applicant recognized the problem with the fire and explosion hazards of sulfur. Blending sulfur with an inert liquid reduces or eliminates the fire and explosion hazards of sulfur. Sulfur may be provided as sulfurized oils, disulfide oils, and other hydrocarbon streams containing naturally occurring sulfur compounds.

The sulfur-ester bottoms mixture may contain about 1 weight percent to about 50 weight percent of the sulfur. In certain embodiments, a sulfur-ester bottoms mixture may contain about 1 wt.% to about 45 wt.% of sulfur, or about 10 wt.% to about 40 wt.%, or about 10 wt.% to about 35 wt.%, or about 10 wt.% to about 30 wt.%, or about 10 wt.% to about 25 wt.%, or about 20 wt.% to about 40 wt.%, or about 25 wt.% to about 50 wt.%, or about 1 wt.% to about 10 wt.%.

The crosslinked polymer modified asphalt composition also contains a polymer modified asphalt. Asphalt is one of the most recycled materials in the world. As used in the present disclosure, the terms “asphalt composition”, “asphalt cement”, or “asphalt binder” are used synonymously to refer to a complex mixture of organic materials, solid or semi-solid at ambient temperature, which gradually liquefy when heated, and in which the main constituents are bituminous substances obtained from natural sources or derived from a number of sources such as petroleum, shale oil, coal tar, and the like, as well as the mixtures of two or more of such materials. For example, vacuum tower bottoms produced during the refining of conventional or synthetic petroleum oils are a common residue material useful as asphalt composition. Solvent deasphalting or distillation may produce the asphalt. For example, vacuum tower bottoms produced during the refining of conventional or synthetic petroleum oils is a common residue material useful as an asphalt composition. A “paving asphalt composition”, “paving asphalt cement”, or “paving asphalt binder”, accordingly is an asphalt composition or asphalt cement having characteristics which dispose the composition to use as a paving material. This is contrasted, for example, with an asphalt composition suited for use as a roofing material. “Roofing asphalts”, usually have a higher softening point and are thus more resistant to flow from heat on roofs. The higher softening point is generally imparted by the air blowing processes by which they are commonly produced. Paving asphalt mixtures may be formed and applied in a variety of ways, as well understood by those skilled in the art.

Solvent deasphalting (SDA) bottoms may be used as part or all of the asphalt of the product blend. SDA bottoms are obtained from suitable feeds such as vacuum tower bottoms, reduced crude (atmospheric), topped crude, and hydrocarbons comprising an initial boiling point of about 450° C. or above. In certain embodiments, the SDA bottoms contain hydrocarbons comprising an initial boiling point of about 500° C. or above, or about 540° C. or above. The SDA bottoms are obtained from vacuum tower bottoms. Solvent deasphalting can be carried out at temperatures of 93-148° C. After solvent deasphalting, the resulting SDA bottoms have a boiling point above 510° C. and a penetration of 0 to 70 dmm at 25° C. The type of asphalt used will depend on the particular application intended for the resulting bitumen composition. In certain embodiments, materials have an initial viscosity at 60° C. of 200 to 6000 poises, or about 250 to 4000 poises. The initial penetration range of the base asphalt at 25° C. is 30 to 350 decimillimeter (dmm), or about 50 to 200 dmm, when the intended use of the composition is road paving.

The asphalt composition may be solely or partly material produced by distillation, without any solvent extraction step. Such materials sometimes referred to as “asphalt cement”, have a reduced viscosity relative to SDA bottoms. Such asphalt cement component can have a viscosity of 100 to 5000 poises at 60° C. The asphalt cement component is added in amounts sufficient to provide the resulting asphalt composition with the desired viscosity for the intended application, e.g., 2000 poises at 60° C. for paving applications. For Performance Graded (PG) applications, the asphalt compositions will have a G*/sin delta value in excess of 1.0 kPa at temperatures ranging from 46 to 82° C. The asphalt cement component of reduced viscosity may be obtained from any suitable source, e.g., atmospheric distillation bottoms.

The asphalt is blended with a polymer, ground up tire rubber, or some other plastic-like material that may be dispersed or dissolved in the asphalt to swell and form a matrix known as polymer modified asphalt. Polymers used for modifying asphalts may include Styrene Butadiene (SB), Styrene-Butadiene-Styrene (SBS), and crumb rubber. Crumb rubber is recycled tire rubber which has been ground into very small particles. As such, the polymer modified asphalt may be one of a styrene-butadiene-styrene modified asphalt, styrene butadiene modified asphalt, or crumb rubber modified asphalt. In certain embodiments, the polymer in the crosslinked polymer modified asphalt has one or more monomers selected from the group consisting of butadiene, styrene, vinyl acetate, ethylene, propylene, acrylate, isoprene, and acrylamide.

The polymer modified asphalt described herein is blended for a period of time to allow the matrix to swell so that it is at least 100% larger in volume. In certain embodiments, the polymer modified asphalt is 200% or more of its original volume. In certain embodiments, the polymer is allowed to stay mixed with the asphalt for a period of time sufficient to permit the polymer to digest and swell to a polymer/asphalt matrix 20X, 25X, 28X, or even larger of its original size. This step can take from 0.1 to 24 hours or more, depending on temperature, polymer, polymer size, and amount of asphalt present. Usually, this step will take from 0.5 to 20 hours, and in certain embodiments, this step may be conducted within 1 to 12 hours for polymer swelling. As described herein, the polymer modified asphalt is blended prior to formation of the crosslinked polymer modified asphalt.

In certain embodiments, a method of producing a crosslinked polymer modified asphalt includes blending sulfur with ester bottoms to form a sulfur-ester bottoms mixture. The sulfur-ester bottoms mixture contains about 1 wt.% to about 50 wt.% of the sulfur and about 50 wt.% to about 99 wt.% of the ester bottoms. The sulfur may be blended with the ester bottoms at a temperature ranging from about 15 degrees °C to about 24° C. for a time period ranging from about 10 minutes to about 30 minutes. The method further includes mixing the sulfur-ester bottoms mixture with a polymer modified asphalt to produce a crosslinked polymer modified asphalt. The sulfur-ester bottoms mixture is added to the polymer modified asphalt in an amount to achieve a preselected useable temperature range of the crosslinked polymer modified asphalt composition. The sulfur-ester bottoms mixture may be mixed with the polymer modified asphalt at a temperature range from about 15° C. to about 24° C. for a time period from about 1 hour to about 2 hours.

Certain embodiments include crosslinked polymer modified asphalt with the addition of SB copolymers or SBS copolymers. In certain embodiments, the present disclosure relates to compositions of crosslinked-SBS modified asphalt with an increased low-temperature performance as compared to an SBS modified asphalt. The crosslinked-SBS modified asphalt composition contains SBS modified asphalt and a sulfur-ester bottoms mixture. The sulfur-ester bottoms mixture may contain about 1 wt.% to about 50 wt.% of the sulfur, as described herein.

The sulfur-ester bottoms mixture may also contain about 50 wt.% to about 99 wt.% of ester bottoms. In certain embodiments, a sulfur-ester bottoms mixture may contain about 50 wt.% to about 95 wt.% of ester bottoms, or about 50 wt.% to about 90 wt.%, or about 50 wt.% to about 85 wt.%, or about 50 wt.% to about 80 wt.%, or about 50 wt.% to about 75 wt.%, or about 50 wt.% to about 70 wt.%, or about 50 wt.% to about 65 wt.%, or about 50 wt.% to about 60 wt.%, or about 50 wt.% to about 55 wt.%.

As such, the crosslinked-SBS modified asphalt may contain about 0.1 wt.% to about 0.4 wt.% of the sulfur-ester bottoms mixture. Additionally, the crosslinked-SBS modified asphalt may contain about 99.6 wt.% to about 99.9 wt.% of the SBS modified asphalt. In some embodiments, the crosslinked-SBS modified asphalt may have a strain recovery rate similar to or not less than the strain recovery rate of the SBS modified asphalt. Additionally, the high temperature compliance of the crosslinked-SBS modified asphalt may be within 5% to the high temperature compliance of the SBS modified asphalt.

The compositions described herein may be formed by the methods described below. Methods of producing a crosslinked polymer modified asphalt described herein, are effective in reducing the fire and explosion hazards of sulfur, increasing low-temperature performance of polymer modified asphalt, and improving the elasticity of the asphalt.

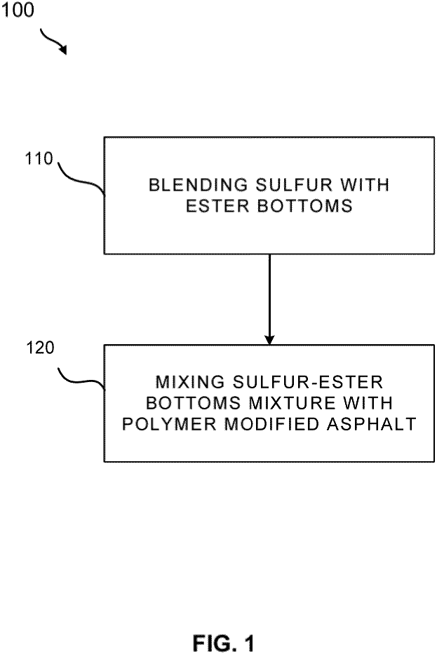

FIG. 1 is an illustrative flow diagram of a method 100 for producing crosslinked polymer modified asphalt, according to an embodiment of the disclosure. The method includes step 110 of blending sulfur with ester bottoms to form a sulfur-ester bottoms mixture. The sulfur-ester bottoms mixture may contain about 1 wt.% to about 50 wt.% of the sulfur, as described herein. In some embodiments, the sulfur may be supplied to a vessel that contains the ester bottoms. Blending the sulfur with the ester bottoms may occur at a temperature ranging from about 15° C. (°C) to about 24° C. or at ambient temperature. This step may take place for a time period ranging from about 10 minutes to about 30 minutes. The blending of the sulfur with the ester bottoms may occur at a temperature less than blending of sulfur with fluxing components, such as gas oils. The blending of the sulfur with the ester bottoms may also occur for a time period less than the blending of sulfur with fluxing components.

In subsequent step 120, the method includes mixing the sulfur-ester bottoms mixture with a polymer modified asphalt to produce a crosslinked polymer modified asphalt. The polymer modified asphalt may be one or more of a styrene-butadiene-styrene modified asphalt, styrene butadiene modified asphalt, or crumb rubber modified asphalt.

Mixing the sulfur-ester bottoms mixture with the polymer modified asphalt may occur at a temperature range from about 15° C. to about 24° C. This step may take place for a time period from about 1 hour to about 2 hours. Blending of the sulfur-ester bottoms mixture with a polymer modified asphalt to produce a crosslinked polymer modified asphalt, may occur at a temperature less than blending of sulfur-ester bottoms mixture with fluxing components and a polymer modified asphalt to produce a different crosslinked modified asphalt. Blending of the sulfur-ester bottoms mixture with a polymer modified asphalt to produce a crosslinked polymer modified asphalt may also occur for a time period less than blending of sulfur-ester bottoms mixture with fluxing components and a polymer modified asphalt to produce a different crosslinked modified asphalt. Certain embodiments of the crosslinked polymer modified asphalt composition include about 99 wt.% to about 99.9 wt.% of the polymer modified asphalt and about 0.1 wt.% to about 1 wt.% of the sulfur-ester bottoms mixture. In certain embodiments, a crosslinked polymer modified asphalt composition contains about 99.8 wt.% of the polymer modified asphalt and about 0.2 wt.% of a sulfur-ester bottoms mixture.

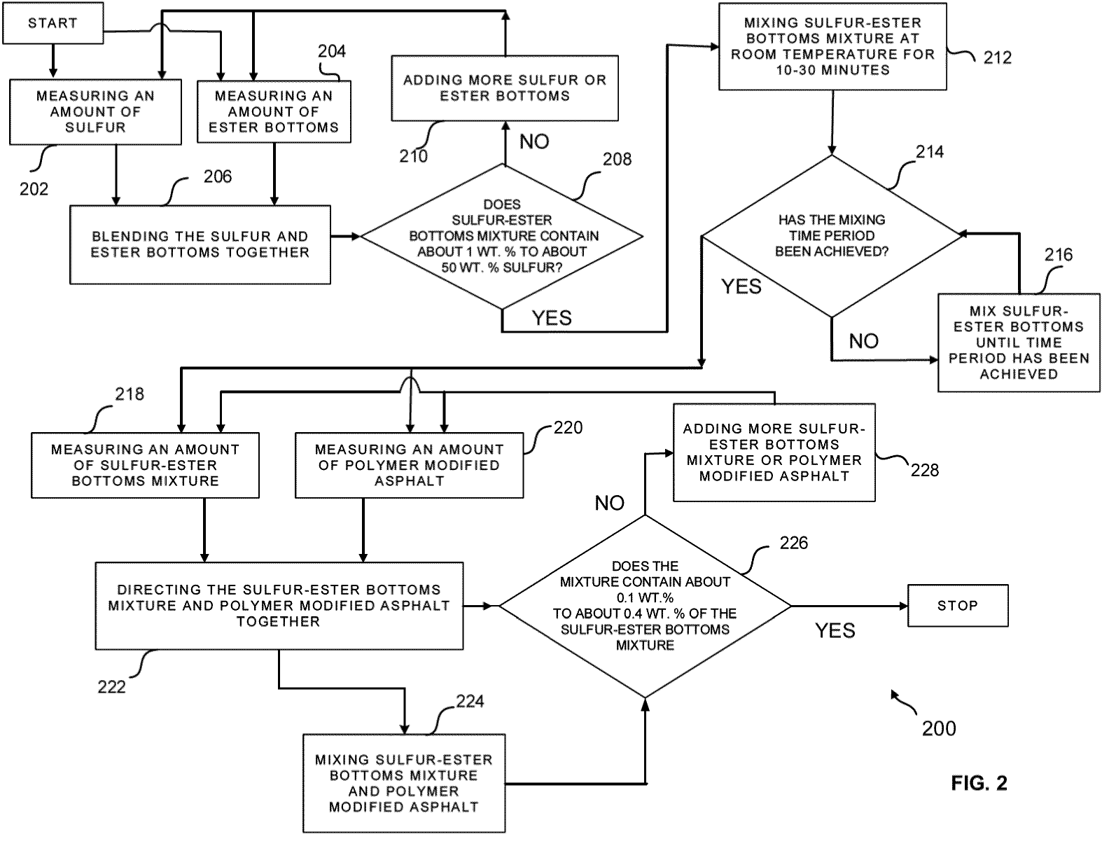

FIG. 2 is a flow diagram for method 200 that illustrates the production of crosslinked polymer modified asphalt from sulfur, ester bottoms, and polymer modified asphalt, according to an embodiment of the disclosure. Embodiments of the method include the step 202, measuring an amount of sulfur. In a concurrent or subsequent step 204, the method may include measuring an amount of ester bottoms. The sulfur may be added to a vessel that contains the ester bottoms in conventional amounts. Due to the fire and explosion hazards, sulfur may be added to the ester bottoms in small amounts.

The method may further include the step 206 of blending the sulfur and the ester bottoms to produce a sulfur-ester bottoms mixture. Sulfur, alternatively, may be blended with a byproduct of soy oil or corn oil. Those wishing to add a large amount of sulfur to the ester bottoms may add a large amount of sulfur to the sulfur-ester bottoms mixture.

The method may further include the step 208 of determining whether the sulfur-ester bottoms mixture contains about 1 wt.% to about 50 wt.% of sulfur. If the sulfur-ester bottoms mixture does not contain the correct amount of sulfur, the method may include the step 210 of adding more sulfur or ester bottoms to the sulfur-ester bottoms mixture by repeating the steps 202, 204, 206, and 208.

If the sulfur-ester bottoms mixture does contain the correct amount of sulfur, the method may further include the step 212 of mixing the sulfur and ester bottoms at an ambient temperature for a time period of about 10 minutes to about 30 minutes. Ambient temperature may include a temperature range of about 15° C. to about 24° C.

The method may further include the step 214 of determining whether the sulfur-ester bottoms has been mixed for about 10 minutes to about 30 minutes. If the sulfur-ester bottoms mixture has not been mixed for about 10 to about 30 minutes, the method may include step 216 of mixing the sulfur-ester bottoms mixture until the time period has been achieved. The time period may also be determined by the amount of sulfur-ester bottoms mixture being mixed and other factors.

If the sulfur-ester bottoms mixture has been mixed for the time period and meets other factors used to determine whether the sulfur-ester bottoms is sufficiently mixed, the method may further include the step 218 of measuring an amount of the sulfur-ester bottoms mixture. Other factors used to determine sufficient mixture are those as understood by those in the art. The amount of sulfur-ester bottoms mixture measured may be used to crosslink with polymer modified asphalt. In a concurrent or subsequent step 220, the method may also include measuring an amount of polymer modified asphalt.

The method may further include the step 222 of directing the sulfur-ester bottoms mixture and polymer modified asphalt together into a vessel. The sulfur-ester bottoms mixture may be directed into a vessel containing the polymer modified asphalt. In a subsequent step 224, the method may include mixing the sulfur-ester bottoms mixture and the polymer modified asphalt to produce a crosslinked polymer modified asphalt. The sulfur-ester bottoms may be injected into the polymer modified asphalt at a controlled rate.

The method may further include the step 226 of determining whether the crosslinked polymer modified asphalt contains a predetermined amount of the sulfur-ester bottoms mixture, such as about 0.1 wt.% to about 0.4 wt.% of the sulfur-ester bottoms mixture. If it is determined that the crosslinked polymer modified asphalt does not contain about 0.1 wt.% to about 0.4 wt.% of the sulfur-ester bottoms mixture, the method may include the step 228 of adding more sulfur-ester bottoms mixture or polymer modified asphalt by repeating steps 218, 220, 222, and 224 until the crosslinked polymer modified asphalt contains about 0.1 wt.% to about 0.4 wt.% of the sulfur-ester bottoms mixture. The sulfur-ester bottoms may be injected into the polymer modified asphalt at a controlled rate until the mixture contains about 0.1 wt.% to about 0.4 wt.% of the sulfur-ester bottoms mixture. If the mixture does contain about 0.1 wt.% to about 0.4 wt.% of the sulfur-ester bottoms mixture, a crosslinked polymer modified asphalt, according to certain embodiments of the disclosure, has been produced.

Determining how the asphalt will respond to stresses and temperature changes is important to preserving the properties of the asphalt. The characteristics of the asphalt may be measured by different parameters including, but not limited to, the asphalt’s high temperature compliance and percent of the multiple stress creep recovery. High temperature compliance may be measured using the original binder (OB) (unaged binder) and a short-term aged binder (rolling thin-film oven (RTFO)).

The composition of the crosslinked polymer modified asphalt may have a strain recovery rate similar to but not less, within acceptable experimental error, than the crosslinked polymer modified asphalt containing neutral oil and without ester bottoms (the control asphalt) as determined using measurements in accordance with the referenced standards. In certain embodiments, the crosslinked polymer modified asphalt may have an increased strain recovery rate as compared to the control asphalt.

The high temperature compliance of the crosslinked polymer modified asphalt was within 10% of the high temperature compliance of the control asphalt. The high temperature compliance of the crosslinked polymer modified asphalt was within 5% of the high temperature compliance of the control asphalt. In certain embodiments, the high temperature compliance of the crosslinked polymer modified asphalt was within 2% of the high temperature compliance of the control asphalt. In certain embodiments, the high temperature compliance of the crosslinked polymer modified asphalt was within 1% of the high temperature compliance of the control asphalt.

High temperature compliance measurement is equivalent to continuous grade, is measured according to ASTM-D7643-16, Standard Practice for Determining the Continuous Grading Temperatures and Continuous Grades for PG Graded Asphalt Binders. Inclusion of the renewable and/or recyclable products, such as ester bottoms, does not affect the high temperature compliance of the crosslinked polymer modified asphalt. For example, the grade of the crosslinked polymer modified asphalt was maintained at PG76, even when renewable components like ester bottoms and byproducts of soy oil or corn oil are used in the asphalt compositions.

High Temperature Compliance (HTC) refers to the lesser of the two continuous grade (true grade) temperatures of specification failure: the temperature corresponding to specification failure of the “original” (unaged) asphalt grade and the temperature corresponding to specification failure of the asphalt aged by the Rolling Thin-Film Oven (RTFO) procedure. The true grade temperature is the temperature at which G*/sin δ=1 kPa for the unaged asphalt, and as the temperature at which G*/sin δ=2.2 kPa for asphalt aged by the RTFO procedure, where G* is the complex shear modulus and 6 (delta) is the phase angle, determined on a dynamic shear rheometer according to American Association of State Highway and Transportation Officials (AASHTO) T315-2020, Determining the Rheological Properties of Asphalt Binder Using a Dynamic Shear Rheometer (DSR). The RTFO procedure provides simulated short term aged asphalt binder for physical property testing, that mimic the aging that occurs due to construction and initial service. The basic RTFO procedure takes unaged asphalt binder samples in cylindrical glass bottles and places these bottles in a rotating carriage within an oven. The carriage rotates within the oven while the 163° C. temperature ages the samples for 85 minutes (AASHTO T240-2021). Samples are then stored for use in physical properties tests.

The Multiple Stress Creep Recovery (MSCR) test was introduced to evaluate bituminous or asphalt binders at high service temperatures, and in particular to evaluate the stress or loading resistance of bituminous or asphalt binders using the well-established creep and recovery test concepts. In the MSCR test, two separate parameters can be determined-non-recoverable creep compliance (Jₙᵣ) and percentage of recovery (MSCR Recovery) during each loading cycle. Asphalt binders that meet the appropriate Jₙᵣ specification are expected to minimize the asphalt binder’s contribution to rutting. Thus, it is desirable to provide modified asphalt binders that are designed to reduce rutting and comply with both the non-recoverable creep and the elastic recovery requirements of the MSCR test.

The percent recovery, or elasticity, is a measure of the tensile properties of the polymer modified asphalt. Percent recovery is the ratio of the difference between the peak strain and the residual strain to the peak strain, expressed as a percentage (% R). % R is a measure of the elastic response of an asphalt binder at a given temperature and applied stress level, generally at 3.2 kPa (% R_{3.2}). Recovery is indicative of how readily an asphalt binder sample will return to its original shape after being subjected to a load or stress. A % R greater than about 40% is considered to be good.

As described here, the production of crosslinked polymer modified asphalt by blending the mixture of sulfur and a renewable byproduct with the unmodified asphalt does not lessen the strain recovery rate of the polymer modified asphalt, and the high temperature compliance is about equal to or about ± 5% of the high temperature compliance of the crosslinked polymer modified asphalt containing a neutral oil and without the ester bottoms. The strain recovery rate of the crosslinked polymer modified asphalt with the sulfur-ester bottoms mixture is not less than the strain recovery rate of the crosslinked polymer modified asphalt containing a neutral oil and without the ester bottoms.

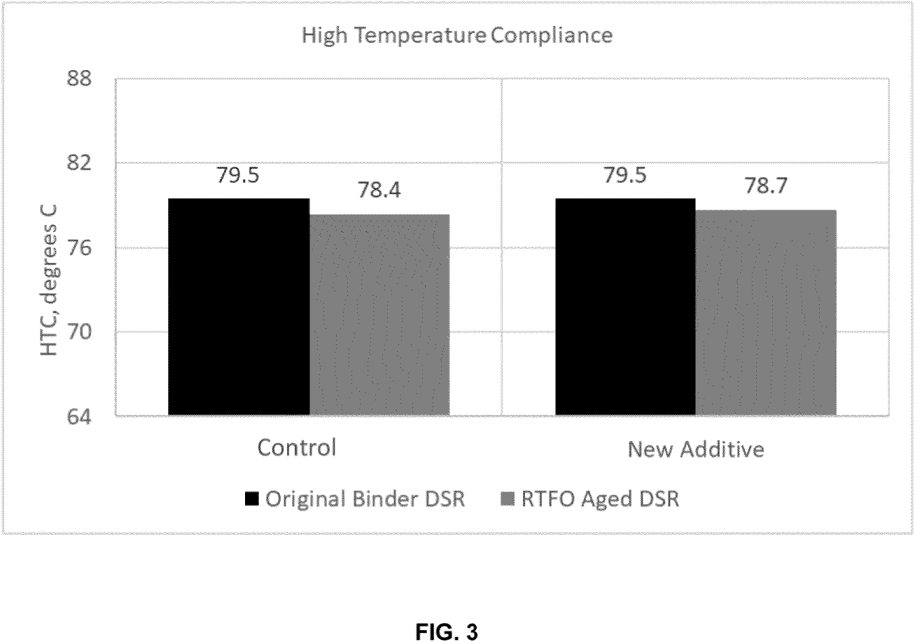

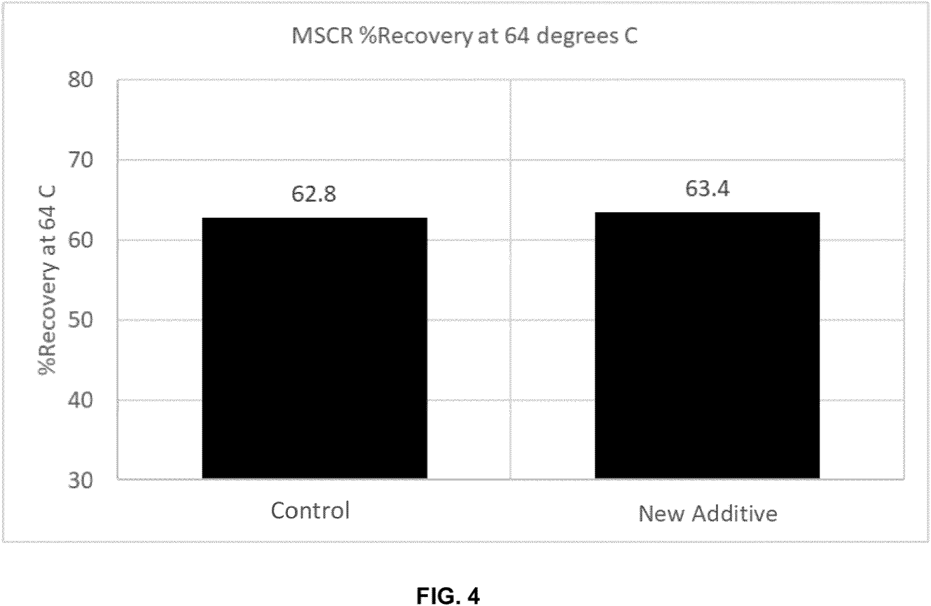

FIG. 3 and FIG. 4, show the results of tests conducted with a crosslinked polymer modified asphalt containing 0.2 wt.% of the sulfur-ester bottoms mixture, labeled as New Additive. The control is a crosslinked polymer modified asphalt containing neutral oil and without ester bottoms, where the sulfur is present as a slurry in neutral oil. Such neutral oils are purchased by refiners at an additional expense to the refinery.

FIG. 3 is a graphical representation of a comparison of the high temperature compliance measured by unaged binder (OB) and rolling thin-film oven (RTFO) of a control sample and crosslinked polymer modified asphalt. As shown, high temperature compliance of the crosslinked polymer modified asphalt is within ±1% to the high temperature compliance of the control. As such, the addition of ester bottoms to the sulfur has minimal impact on the high temperature compliance of the polymer modified asphalt. Thus, as the performance grade of the crosslinked polymer modified asphalt is similar to the performance grade of the crosslinked polymer modified asphalt containing neutral oil and without ester bottoms, the renewable ester bottoms can be used in the manufacture of crosslinked polymer modified asphalt.

The addition of one or more of a styrene-butadiene-styrene modified asphalt, styrene butadiene modified asphalt, or crumb rubber modified asphalt to sulfur-ester bottoms should similarly have a high temperature compliance as compared to the control sample. As such, the crosslinked polymer modified asphalt described herein provides the same performance grade. Additionally, the high temperature compliance is within ±5% of a crosslinked polymer modified asphalt where the sulfur is presented in a slurry with neutral oil, as well as the fire and explosion hazards are reduced or eliminated.

FIG. 4 is a graphical representation of a comparison of the rate of recovery of a control sample (crosslinked polymer modified asphalt with a neutral oil and without ester bottoms) and a crosslinked polymer modified asphalt (with ester bottoms), labeled as New Additive. As shown, a strain recovery rate of the crosslinked polymer modified asphalt with ester bottoms (%R of 63.4) is not less than the strain recovery rate of the crosslinked polymer modified asphalt with a neutral oil and without the ester bottoms (%R of 62.8) as measured under MSCR test. As such, the crosslinked polymer modified asphalt with ester bottoms described herein provides better elasticity, as well as reduces or eliminates fire and explosion hazards. The crosslinked polymer modified asphalt with ester bottoms may have desirable applications such as but not limited to paving asphalt, asphalt emulsions, cutback asphalts, and roofing flux.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

This application claims priority to, and the benefit of U.S. Provisional Application No. 63/265,548, filed Dec. 16, 2021, titled “CROSSLINKED-POLYMER MODIFIED ASPHALT METHODS AND COMPOSITIONS, FOR REDUCING FIRE AND EXPLOSION HAZARDS AND ENHANCING LOW TEMPERATURE PERFORMANCE,” the disclosures of which are incorporated herein by reference in its entirety.

In the drawings and specifications, several embodiments of compositions and methods to produce a crosslinked polymer modified asphalt have been disclosed, and although specific terms are employed, the terms are used in a descriptive sense only and not for purposes of limitation. Embodiments of systems and methods have been described in considerable detail with specific reference to the illustrated embodiments. However, it will be apparent that various modifications and changes may be made within the spirit and scope of the embodiments of compositions and methods as described in the foregoing specification, and such modifications and changes are to be considered equivalents and part of this disclosure.

What is claimed is:

1. A method of producing a crosslinked polymer modified asphalt, the method comprising:
blending sulfur with ester bottoms to form a sulfur-ester bottoms mixture containing about 1 weight percent (wt.%) to about 50 wt.% of the sulfur; and
mixing the sulfur-ester bottoms mixture with a polymer modified asphalt to produce a crosslinked polymer modified asphalt.

2. The method of claim 1, wherein the crosslinked polymer modified asphalt contains about 0.1 wt.% to about 0.4 wt.% of the sulfur-ester bottoms mixture.

3. The method of claim 1, further comprising:
reacting methanol and dry oil to generate reaction products, the reaction products including at least methyl ester and glycerin, the dry oil including one or more of a vegetable oil or an animal fat that has at least some moisture removed therefrom prior to reaction with the methanol;
removing at least a portion of the glycerin from the reaction products to leave an ester phase; and
distilling the ester phase to separate purified methyl esters and recover distillation bottoms as the ester bottoms.

4. The method of claim 1, wherein the blending of the sulfur with the ester bottoms occurs at a temperature ranging from about 15° C. (°C) to about 24° C.

5. The method of claim 1, wherein mixing the sulfur-ester bottoms mixture with the polymer modified asphalt occurs at a temperature range from about 15° C. to about 24° C. for a time period from about 1 hour to about 2 hours.

6. The method of claim 1, wherein a strain recovery rate of the crosslinked polymer modified asphalt with the sulfur-ester bottoms mixture is not less than the strain recovery rate of a crosslinked polymer modified asphalt containing a neutral oil and without the ester bottoms.

7. The method of claim 1, wherein a high temperature compliance of the crosslinked polymer modified asphalt with the sulfur-ester bottoms mixture is within 5% of the high temperature compliance of a crosslinked polymer modified asphalt containing a neutral oil and without the ester bottoms.

8. The method of claim 1, wherein the polymer modified asphalt is one or more of a styrene-butadiene-styrene modified asphalt, styrene butadiene modified asphalt, or crumb rubber modified asphalt.

9. A crosslinked polymer modified asphalt composition comprising about 99.6 weight percent (wt.%) to about 99.9 wt.% of the polymer modified asphalt and about 0.1 wt.% to about 0.4 wt.% of a sulfur-ester bottoms mixture.

10. The composition of claim 9, wherein the sulfur-ester bottoms mixture contains about 1 wt.% to about 50 wt.% of the sulfur.

11. The composition of claim 9, wherein the polymer modified asphalt is one of a styrene-butadiene-styrene modified asphalt, styrene butadiene modified asphalt, or crumb rubber modified asphalt.

12. The composition of claim 9, wherein a strain recovery rate of the crosslinked polymer modified asphalt with the sulfur-ester bottoms mixture is not less than the strain recovery rate of a crosslinked polymer modified asphalt containing a neutral oil and without the ester bottoms.

13. The composition of claim 9, wherein a high temperature compliance of the crosslinked polymer modified asphalt with the sulfur-ester bottoms mixture is within 5% of the high temperature compliance of a crosslinked polymer modified asphalt containing a neutral oil and without the ester bottoms.

14. The composition of claim 9, wherein the ester bottoms are obtained as distillation bottoms of a distilled methyl ester product that results from reaction between methanol and at least one of vegetable oil or animal fat from which glycerin is settled and removed from the methyl ester product prior to distillation.

15. A crosslinked-styrene-butadiene-styrene (SBS) modified asphalt composition comprising SBS modified asphalt and a sulfur-ester bottoms mixture, the sulfur-ester bottoms mixture containing about 1 weight percent (wt.%) to about 50 wt.% of sulfur and about 50 wt.% to about 99 wt.% of ester bottoms.

16. The composition of claim 15, wherein the crosslinked-SBS modified asphalt contains 99.6 wt.% to about 99.9 wt.% of the SBS modified asphalt.

17. The composition of claim 16, wherein the crosslinked-SBS modified asphalt contains about 0.2 wt.% of the sulfur-ester bottoms mixture.

18. The composition of claim 16, wherein a strain recovery rate of the crosslinked-SBS modified asphalt with the sulfur-ester bottoms mixture is not less than the strain recovery rate of a crosslinked-SBS modified asphalt containing a neutral oil and without the ester bottoms.

19. The composition of claim 16, wherein a high temperature compliance of the crosslinked-SBS modified asphalt with the sulfur-ester bottoms mixture is within 5% of the high temperature compliance of a crosslinked-SBS modified asphalt containing a neutral oil and without the ester bottoms.

20. The composition of claim 15, wherein the ester bottoms are obtained as distillation bottoms of a distilled methyl ester product that results from reaction between methanol and at least one of vegetable oil or animal fat from which glycerin is settled and removed from the methyl ester product prior to distillation.
